(19) United States
(12) Patent Application Publication
(10) Pub. No.: US 2011/0206964 A1
(43) Pub. Date: Aug. 25, 2011

(54) COOLING SYSTEM FOR A BATTERY ASSEMBLY

(75) Inventors: Kennedy U. Odumodu, Ann Arbor, MI (US); Paul J. Boor, Macomb, MI (US); Derek R. Weber, Mendon, NY (US)

(73) Assignee: GM GLOBAL TECHNOLOGY OPERATIONS, INC., DETROIT, MI (US)

(21) Appl. No.: 12/711,575

(22) Filed: Feb. 24, 2010

(51) Int. Cl. H01M 10/50; F28D 15/00; B23P 11/00

(52) U.S. Cl. 429/120; 165/104.19; 29/505

(57) ABSTRACT

A cooling assembly for a battery assembly including at least one conduit and at least one cooling plate, the conduit having a flexible portion to facilitate a relative movement between an inlet end and an outlet end thereof to selectively expand and contract the cooling assembly, and the cooling plate including a flow channel formed therein, wherein at least one battery cell is disposed adjacent and in heat transfer communication with the at least one cooling plate to transfer heat from the at least one battery cell to a fluid disposed in the flow channel.

### FIELD OF THE INVENTION

The present disclosure relates to a component for a battery system, and more particularly to a cooling system for a battery assembly of the battery system and a method of assembly thereof.

### BACKGROUND OF THE INVENTION

A battery cell has been proposed as a clean, efficient and environmentally responsible power source for electric vehicles and various other applications. One type of battery cell is known as a lithium-ion battery. The lithium-ion battery is rechargeable and can be formed into a wide variety of shapes and sizes so as to efficiently fill available space in electric vehicles. A plurality of individual lithium-ion battery cells can be provided in a battery assembly to provide an amount of power sufficient to operate electric vehicles.

Lithium-ion battery cells are known to generate heat during a charge and discharge cycle of operation. Overheating of the battery cells or an exposure thereof to high-temperature environments, may undesirably affect the operation of the battery system. Accordingly, cooling systems are typically employed with the battery cells in the battery assembly. Prior art cooling systems require fluid-tight joining of numerous parts and components making the cooling system susceptible to leakage. To ensure fluid-tight joining of the parts and components and to minimize susceptibility to leakage, processes and equipment used to assemble the cooling system is highly automated, complex, and cost prohibitive.

Therefore, it is desirable to produce a cooling system for a battery assembly and a method of assembly thereof, wherein a quality, durability, and manufacturability thereof are maximized, and a cost and complexity thereof are minimized.

### SUMMARY OF THE INVENTION

In concordance and agreement with the present invention, a cooling system for a battery assembly and a method of assembly thereof, wherein a quality, durability, and manufacturability of thereof are maximized, and a cost and complexity thereof are minimized, are surprisingly discovered.

In an embodiment, the cooling system for a battery assembly comprises: a first conduit including a flexible portion to facilitate a relative movement between an inlet end and an outlet end thereof to selectively expand and contract the cooling system, wherein the first conduit receives a fluid therein; and at least one cooling plate coupled to the first conduit, the cooling plate including a flow channel formed therein for receiving the fluid therein, wherein the fluid absorbs heat from at least one battery cell of the battery assembly.

In another embodiment, the battery assembly for a battery system comprises: a cooling system including a first conduit including a flexible portion to facilitate a relative movement between an inlet end and an outlet end thereof to selectively expand and contract the cooling system, wherein the first conduit receives a fluid therein, and at least one cooling plate coupled to the first conduit, the cooling plate including a flow channel formed therein for receiving the fluid therein, wherein the cooling plate includes at least one substantially planar surface; and at least one battery cell including at least one substantially planar surface, wherein the at least one substantially planar surface of the at least one battery cell is in heat transfer communication with the at least one substantially planar surface of the cooling plate to facilitate a transfer of heat from the at least one battery cell to the fluid disposed in the cooling system.

In another embodiment, the method for assembly a battery assembly, the method comprises the steps of: providing a first conduit including a flexible portion to facilitate a relative movement between an inlet end and an outlet end thereof to selectively expand and contract the cooling system; providing at least one cooling plate coupled to the first conduit, the at least one cooling plate including a flow channel formed therein for receiving a fluid therein; providing at least one battery cell; causing an expansion of the cooling system; disposing the at least one battery cell adjacent the at least one cooling plate; and causing a compression of the cooling system to facilitate a contact of the at least one cooling plate with the at least one battery cell, wherein the at least one cooling plate is in heat transfer communication with the at least one battery cell.

### DRAWINGS

The above, as well as other advantages of the present disclosure, will become readily apparent to those skilled in the art from the following detailed description, particularly when considered in the light of the drawings described herein.

FIG. 1 is an exploded schematic perspective view of a battery assembly according to an embodiment of the invention, showing the battery assembly in a first position;

FIG. 2 is a schematic perspective view of the battery assembly illustrated in FIG. 1, showing the battery assembly in a second position;

FIG. 3 is a cross-sectional elevational view of a battery assembly according to another embodiment of the invention, showing the battery assembly in a first position; and

FIG. 4 is a cross-sectional elevational view of the battery assembly illustrated in FIG. 3, showing the battery assembly in a second position.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, are not necessary or critical.

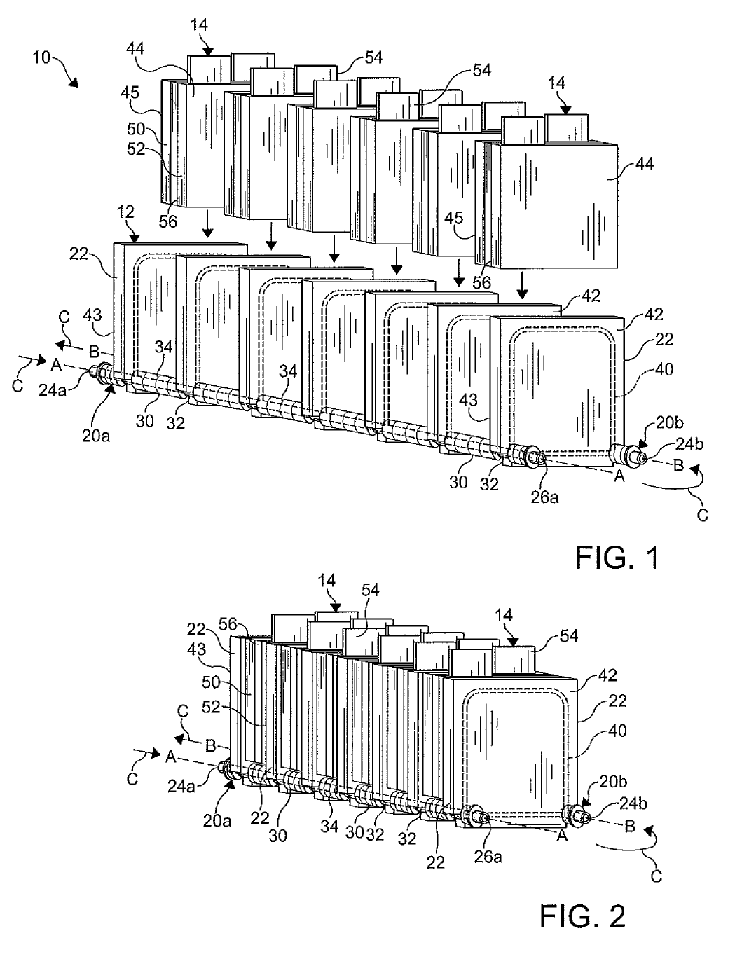

FIGS. 1-2 show a battery assembly 10 for a battery system according to an embodiment of the present invention. The battery system can be used in any suitable application such as an electric vehicle, for example. The battery assembly 10 includes a cooling system 12 and a plurality of battery cells 14. Additional or fewer battery cells 14 than shown can be employed as desired. In the embodiment shown, the cooling system 12 includes a pair of conduits 20a, 20b and a plurality of cooling plates 22. It is understood that the conduits 20a, 20b can be affixed to the cooling plates 22 by any suitable method as desired such as by a welding process, a brazing process, an adhesive, fasteners, and the like, for example. It is further understood that the conduits 20a, 20b can be integrally formed with the cooling plates 22 if desired. The conduits 20a, 20b and the cooling plates 22 can be formed from any suitable material as desired such as a plastic material and a metal material, for example.

The conduits 20a, 20b include respective inlet ends 24a, 24b and respective outlet ends 26a, (not shown) formed thereon. The inlet end 24a of the conduit 20a is in fluid communication with a source of fluid (not shown) having a fluid disposed therein. It is understood that the source of fluid can be any source of fluid as desired such as a coolant tank, for example. It is further understood that the fluid can be any fluid as desired such as a coolant, water, and the like, for example. The outlet end 26a of the conduit 20a is in fluid communication with the inlet end 24a thereof and the inlet end 24b of the conduit 20b. It is understood that the outlet end 26a can be in fluid communication with the inlet end 24b by any means as desired such as through another conduit or battery assembly of the battery system, for example. The outlet end of the conduit 20b is in fluid communication with the inlet end 26b thereof and the source of fluid. Alternatively, the outlet end of the conduit 20b may be in fluid communication with another battery assembly, vehicle component, or external depository for fluid disposal if desired.

Each of the conduits 20a, 20b includes a plurality of bellows-like flexible portions 30 disposed between a plurality of substantially rigid portions 32 in an alternating pattern. Alternatively, the conduits 20a, 20b may be formed entirely from the flexible portions 30 if desired. The flexible portions 30 facilitate a relative movement between the respective inlet ends 24a, 24b and outlet ends 26a, (not shown) of the conduits 20a, 20b to selectively expand and contract the cooling system 12. Particularly, the flexible portions 30 include at least one convolution 34 formed therein. The convolution 34 of the flexible portions 30 facilitates an expansion of the conduits 20a, 20b along respective longitudinal axes A, B thereof to a first position as shown in FIG. 1 and a contraction of the conduits 20a, 20b along the axes A, B thereof to a second position as shown in FIG. 2. The conduits 20a, 20b can be expanded and contracted manually, automatically, or any combination thereof as desired. In a non-limiting example, the conduits 20a, 20b can be expanded to the first position by disposing a pressurized fluid such as a pressurized coolant, for example, therethrough. Apertures (not shown) are formed in at least one of the rigid portions 32 of the conduits 20a, 20b to facilitate fluid communication between the conduits 20a, 20b and the cooling plates 22. Alternatively, the apertures can be formed in the flexible portions 30 if desired.

In the embodiment shown, the cooling system 12 includes multiple cooling plates 22. It is understood, however, that the cooling system 12 may include additional or fewer cooling plates 22 than shown as desired. Each of the cooling plates 22 includes a flow channel 40 formed therein as indicated by dashed lines in FIGS. 1 and 2. Although the cooling plates 22 shown include a single flow channel 40, it is understood that additional flow channels 40 can be formed in the cooling plates 22 as desired. The flow channel 40 receives the fluid from the source of fluid therein. As illustrated, the flow channel 40 is formed adjacent a periphery of each of the cooling plates 22. It is understood, however, that the flow channel 40 can be formed elsewhere in the cooling plate 22 as desired. Corresponding apertures (not shown) formed in the cooling plates 22 are aligned and cooperate with the apertures formed in the conduits 20a, 20b to form a flow path therebetween and facilitate a flow of the fluid into and from the flow channel 40.

The cooling plates 22 further include substantially planar surfaces 42, 43. The surfaces 42, 43 of the cooling plates 22 are configured to contact substantially planar surfaces 44, 45 of the battery cells 14 to facilitate a transfer of heat from the battery cells 14 to the fluid disposed in the flow channels 40. A thickness of the cooling plates 22 can be any thickness as desired to maximize an efficiency of the battery system. In a non-limiting example, the thickness of the cooling plates 22 is in a range of about 0.05 mm to about 1.0 mm.

As illustrated, the battery cells 14 are prismatic battery cells such as a prismatic lithium ion (Li-ion) battery cell, for example. It is understood that other battery cells 14, employing different structure and electrochemistry, may be used as desired. Each of the battery cells 14 includes a first battery unit 50 and a second battery unit 52. An electrical tab 54 is at least partially disposed in each of the first battery unit 50 and the second battery unit 52. The electrical tabs 54 of the battery units 50, 52 connect the battery cell 14 in series and parallel with an interconnect board (not shown). The battery cells 14 shown further include a spacer 56 disposed between the first battery unit 50 and the second battery unit 52. In a non-limiting example, the spacer 56 is formed from a nonconductive foam that deforms with a contraction of the battery assembly 10 as shown in FIG. 2. The spacer 56 militates against an undesirable movement of the battery units 50, 52 during operation of the battery assembly 10. It is understood that the spacer 56 can be formed from any suitable material as desired.

The battery assembly 10 may further include additional components as desired such as end frames, end assemblies, compression rods, retention loops, and assembly covers, for example.

To assemble the battery assembly 10, the cooling plates 22 are affixed to the rigid portions 32 of the conduits 20a, 20b. The apertures of the cooling plates 22 are aligned and cooperate with the apertures formed in the rigid portions 32 of the conduits 20a, 20b to form the flow paths therebetween. Thereafter, the flexible portions 30 of the conduits 20a, 20b are expanded along the longitudinal axes A, B thereof to define a space between each of the cooling plates 22 as shown in FIG. 1. The battery cells 14 are then disposed in the space between the cooling plates 22 in heat transfer communication with the cooling plates 22. The space between the cooling plates 22 militates against damage to the battery cells 14 during an assembly of the battery assembly 10. The flexible portions 30 of the conduits 20a, 20b are then contracted along the longitudinal axes A, B thereof to cause a compression of the battery assembly 10 to the second position as shown in FIG. 2. At least one of the surfaces 42, 43 of the cooling plates 22 contacts at least one of the surfaces 44, 45 of the battery cells 14 under the compression of the battery assembly 10.

In use of the battery assembly 10, the fluid is supplied from the source of fluid to the inlet 24a of the conduit 20a. The fluid is circulated through the conduits 20a, 20b as indicated by the arrows C, through the flow paths formed between the conduit 20a and the cooling plates 22, and into the flow channel 40 of the cooling plates 22 to absorb heat from the battery cells 14. The heated fluid is then exhausted from the cooling plates 22, through the flow paths formed between the cooling plates 22 and the conduit 20b, and from the outlet of the conduit 20b.

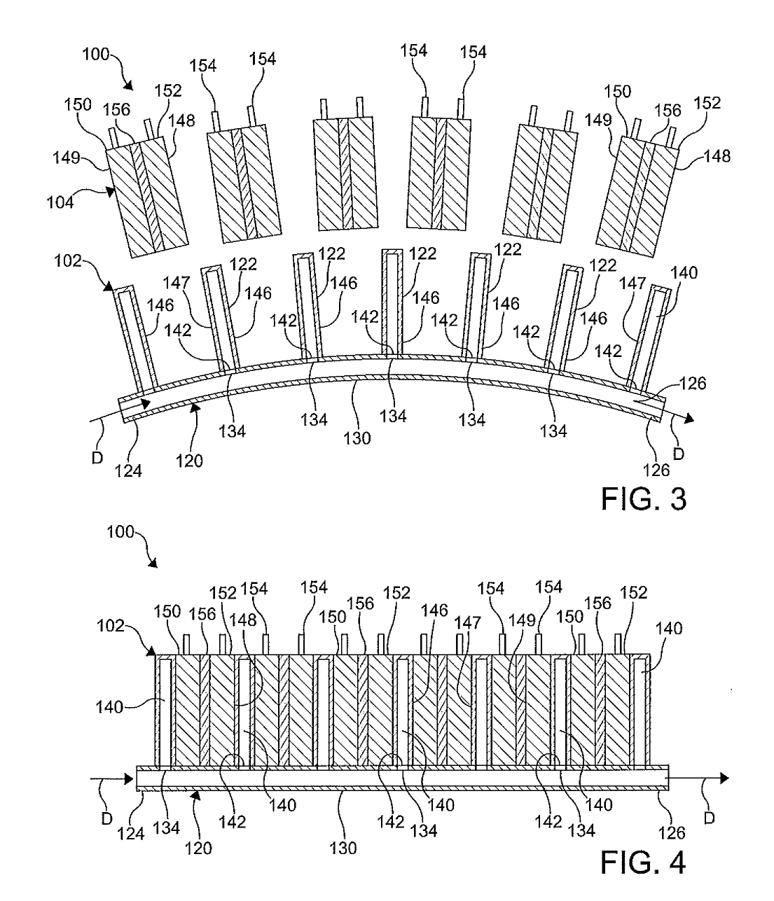

FIGS. 3-4 show a battery assembly 100 for a battery system according to another embodiment of the present invention. The battery system can be used in any suitable application such as an electric vehicle, for example. The battery assembly 100 includes a cooling system 102 and a plurality of battery cells 104. Additional or fewer battery cells 104 than shown can be employed as desired. In the embodiment shown, the cooling system 102 includes a conduit 120 and a plurality of cooling plates 122 formed thereon. It is understood that the cooling plates 122 can be affixed to the conduit 120 by any suitable method as desired such as by a welding process, a brazing process, an adhesive, fasteners, and the like, for example. It is further understood that the conduit 120 can be integrally formed with the cooling plates 122 if desired. The conduit 120 and the cooling plates 122 can be formed from any suitable material as desired such as a plastic material and a metal material, for example.

The conduit 120 includes an inlet end 124 and an outlet end 126 formed therein. The inlet end 124 of the conduit 120 is in fluid communication with a source of fluid (not shown) having a fluid disposed therein. It is understood that the source of fluid can be any source of fluid as desired such as a coolant tank, for example. It is further understood that the fluid can be any fluid as desired such as a coolant, water, and the like, for example. The outlet end 126 of the conduit 120 is in fluid communication with the source of fluid. Alternatively, the outlet end 126 may be in fluid communication with another battery system, vehicle component, or external depository for fluid disposal if desired.

In the embodiment shown, the conduit 120 includes a flexible portion 130. The flexible portion 130 facilitates a relative movement between an inlet end 124 and an outlet end 126 of the conduit 120 to selectively expand and contract the cooling system 102. Particularly, the flexible portion 130 facilitates a bending of the conduit 120 to cause an expansion of the conduit 120 to a first position as shown in FIG. 3 and a contraction of the conduit 120 to a second position as shown in FIG. 4. The conduit 120 can be expanded and contracted manually, automatically, or any combination thereof as desired. In a non-limiting example, the conduit 120 can be expanded to the first position by disposing a pressurized fluid such as a pressurized coolant, for example, therethrough. Apertures 134 formed in the conduit 120 facilitate fluid communication between the conduit 120 and the cooling plates 122.

In the embodiment shown, the cooling system 102 includes multiple cooling plates 122. It is understood, however, that the cooling system 102 may include additional or fewer cooling plates 122 than shown as desired. Each of the cooling plates 122 includes a flow channel 140 formed therein. Although the cooling plates 122 shown include a single flow channel 140, it is understood that additional flow channels 140 can be formed in the cooling plates 122 as desired. The flow channel 140 receives the fluid from the source of fluid therein. The flow channel 140 is formed adjacent a periphery of each of the cooling plates 122. It is understood, however, that the flow channel 140 can be formed elsewhere in the cooling plate 122 as desired. Corresponding apertures 142 formed in the cooling plates 122 are aligned and cooperate with the apertures 134 formed in the conduit 120 to form a flow path therebetween and facilitate a flow of the fluid into and from the flow channel 140.

Substantially planar surfaces 146, 147 of the cooling plates 122 are configured to contact substantially planar surfaces 148, 149 of the battery cells 14 to facilitate a transfer of heat from the battery cells 104 to the fluid disposed in the flow channels 140. A thickness of the cooling plates 122 can be any thickness as desired to maximize an efficiency of the battery system. In a non-limiting example, the thickness of the cooling plates 122 is in a range of about 0.05 mm to about 1.0 mm.

As illustrated, the battery cells 104 are prismatic battery cells such as a prismatic lithium ion (Li-ion) battery cell, for example. It is understood that other battery cells 104, employing different structure and electrochemistry, may be used as desired. Each of the battery cells 104 includes a first battery unit 150 and a second battery unit 152. An electrical tab 154 is at least partially disposed in each of the first battery unit 150 and the second battery unit 152. The electrical tabs 154 of the battery units 150, 152 connect the battery cell 104 in series and parallel with an interconnect board (not shown). The battery cells 104 shown further include a spacer 156 disposed between the first battery unit 150 and the second battery unit 152. In a non-limiting example, the spacer 156 is formed from a nonconductive foam that deforms with a contraction of the battery assembly 100 as shown in FIG. 4. The spacer 156 militates against an undesirable movement of the battery units 150, 152 during operation of the battery assembly 100. It is understood that the spacer 156 can be formed from any suitable material as desired.

The battery assembly 100 may further include additional components as desired such as end frames, end assemblies, compression rods, retention loops, and assembly covers, for example.

To assemble the battery assembly 100, the cooling plates 122 are affixed to the conduit 120. The apertures of the cooling plates 122 are aligned and cooperate with the apertures formed in the conduits 120 to form the flow paths therebetween. Thereafter, the flexible portion 130 of the conduit 120 is expanded to arch the conduit 120, causing the cooling plates 122 to slope outwardly from the conduit 120. Accordingly, a space between each of the cooling plates 122 is wider at a top of the cooling plates and narrower at a base of the cooling plates 122, as shown in FIG. 3. The battery cells 104 are then disposed in the space between the cooling plates 122 in heat transfer communication with the cooling plates 122. The space between the cooling plates 122 militates against damage to the battery cells 104 during an assembly of the battery assembly 100. The flexible portion 130 of the conduit 120 is then contracted, causing the cooling plates 122 to be substantially parallel relative to adjacent cooling plates 122 and causing a compression of the battery assembly 100 to the second position as shown in FIG. 4. At least one of the surfaces 146, 147 of the cooling plates 122 contacts at least one of the surfaces 148, 149 of the battery cells 104 under the compression of the battery assembly 100.

In use of the battery assembly 100, the fluid is supplied from the source of fluid to the inlet 124 of the conduit 120. The fluid is circulated through the conduit 120 as indicated by arrows D, through the flow paths formed between the conduit 120 and the cooling plates 122, and into the flow channel 140 of the cooling plates 122 to absorb heat from the battery cells 104. The heated fluid is then exhausted from the cooling plates 122, through the flow paths formed between the cooling plates 122 and the conduit 120 and from the outlet 126 of the conduit 120.

While certain representative embodiments and details have been shown for purposes of illustrating the invention, it will be apparent to those skilled in the art that various changes may be made without departing from the scope of the disclosure, which is further described in the following appended claims.

What is claimed is:

1. A cooling system for a battery assembly comprising:
a first conduit including a flexible portion to facilitate a relative movement between an inlet end and an outlet end thereof to selectively expand and contract the cooling system, wherein the first conduit receives a fluid therein; and
at least one cooling plate coupled to the first conduit, the cooling plate including a flow channel formed therein for receiving the fluid therein, wherein the fluid absorbs heat from at least one battery cell of the battery assembly.

2. The cooling system of claim 1, wherein the cooling system further comprises a second conduit including a flexible portion to facilitate a relative movement between an inlet end and an outlet end thereof to selectively expand and contract the cooling system.

3. The cooling system of claim 2, wherein the flexible portion of at least one of the first conduit and the second conduit facilitates an axial expansion and contraction of at least one of the first conduit and the second conduit.

4. The cooling system of claim 2, wherein the flexible portion of at least one of the first conduit and the second conduit facilitates a bending of at least one of the first conduit and the second conduit to facilitate an expansion and contraction of at least one of the first conduit and the second conduit.

5. The cooling system of claim 2, wherein at least one of the first conduit and the second conduit includes apertures formed therein to facilitate fluid communication between the conduit and the at least one cooling plate.

6. The cooling system of claim 2, wherein each of the first conduit and the second conduit includes a rigid portion having apertures formed therein to facilitate fluid communication between the conduits and the at least one cooling plate.

7. The cooling system of claim 2, wherein the at least one cooling plate is integrally formed with at least one of the first conduit and the second conduit.

8. The cooling system of claim 1, wherein the at least one cooling plate includes a substantially planar surface in heat transfer communication with a substantially planar surface of the at least one battery cell.

9. The cooling system of claim 1, wherein the flow channel is formed adjacent a periphery of the at least one cooling plate.

10. A battery assembly for a battery system comprising:
a cooling system including a first conduit including a flexible portion to facilitate a relative movement between an inlet end and an outlet end thereof to selectively expand and contract the cooling system, wherein the first conduit receives a fluid therein, and at least one cooling plate coupled to the first conduit, the cooling plate including a flow channel formed therein for receiving the fluid therein, wherein the cooling plate includes at least one substantially planar surface; and
at least one battery cell including at least one substantially planar surface, wherein the at least one substantially planar surface of the at least one battery cell is in heat transfer communication with the at least one substantially planar surface of the cooling plate to facilitate a transfer of heat from the at least one battery cell to the fluid disposed in the cooling system.

11. The battery assembly of claim 10, wherein the cooling system further comprises a second conduit including a flexible portion to facilitate a relative movement between an inlet end and an outlet end thereof to selectively expand and contract the cooling system.

12. The battery assembly of claim 11, wherein the flexible portion of at least one of the first conduit and the second conduit facilitates an axial expansion and contraction of at least one of the first conduit and the second conduit.

13. The battery assembly of claim 11, wherein the flexible portion of at least one of the first conduit and the second conduit facilitates a bending of at least one of the first conduit and the second conduit to facilitate an expansion and contraction of at least one of the first conduit and the second conduit.

14. The battery assembly of claim 11, wherein at least one of the first conduit and the second conduit includes apertures formed therein to facilitate fluid communication between the conduit and the at least one cooling plate.

15. The battery assembly of claim 11, wherein each of the first conduit and the second conduit include a rigid portion having apertures formed therein to facilitate fluid communication between the conduits and the at least one cooling plate.

16. The battery assembly of claim 11, wherein the at least one cooling plate is integrally formed with at least one of the first conduit and the second conduit.

17. A method for assembly a battery assembly, the method comprising the steps of:
providing a first conduit including a flexible portion to facilitate a relative movement between an inlet end and an outlet end thereof to selectively expand and contract the cooling system;
providing at least one cooling plate coupled to the first conduit, the at least one cooling plate including a flow channel formed therein for receiving a fluid therein;
providing at least one battery cell;
causing an expansion of the cooling system;
disposing the at least one battery cell adjacent the at least one cooling plate; and
causing a compression of the cooling system to facilitate a contact of the at least one cooling plate with the at least one battery cell, wherein the at least one cooling plate is in heat transfer communication with the at least one battery cell.

18. The method of claim 17, further comprising the step of: providing a second conduit including a flexible portion to facilitate a relative movement between an inlet end and an outlet end thereof to selectively expand and contract the cooling system.

19. The method of claim 18, wherein the flexible portion of at least one of the first conduit and the second conduit facilitates an axial expansion and contraction of at least one of the first conduit and the second conduit.

20. The method of claim 18, wherein the flexible portion of at least one of the first conduit and the second conduit facilitates a bending of at least one of the first conduit and the second conduit to facilitate an expansion and contraction of at least one of the first conduit and the second conduit.
